(19) United States
(12) Patent Application Publication
(10) Pub. No.: US 2012/0145981 A1
(43) Pub. Date: Jun. 14, 2012

(54) Proceeding and Arrangement in Connection with a Winch for a Sheet or a Halyard on a Sailing Boat

(75) Inventor: Anders Ryberg, Hönö (SE)

(73) Assignee: SELDÉN MAST AB, Västra Frölunda (SE)

(21) Appl. No.: 13/382,546

(22) PCT Filed: Jun. 28, 2010
(86) PCT No.: PCT/SE10/50740

§ 371 Date: Mar. 5, 2012

(30) Foreign Application Priority Data
Jul. 6, 2009 (SE) 0950526-4

(51) Int. Cl. B66D 1/28; B66D 1/74

(52) U.S. Cl. 254/371

(57) ABSTRACT

The instant invention concerns a proceeding and an arrangement in connection with a winch for a sheet or a halyard on a sailing boat. This is, besides for sheeting-in, constructed to also allow veering-out of sheet or halyard rope arranged thereon by means of means that normally otherwise are intended for sheeting-in, more precisely a crank possibly having an appurtenant transmission integrated in the winch or the corresponding motor drive and appurtenant transmission, for driving of a drum belonging to the winch and a self-tailing unit arranged at the upper end of the same. The last-mentioned one has upper and lower rope guide rings as well as means in the form of an expedient arm for directing the rope into and out of the self-tailing unit in a controlled way. The invention embraces suspension and spring-mounting means for at least one of the rope guide rings that are arranged in such a way that this/these obtain(s) a mutually static and dynamic motion pattern. This pattern is such that, in connection with forcing apart the rope guide rings somewhere along the periphery thereof, for instance, by the arrangement of a rope between the same, the corresponding opposite portions of the rope guide rings automatically approach each other, for clamping of the rope arranged therebetween.

### TECHNICAL FIELD

The present invention concerns a proceeding and an arrangement in connection with a winch for a sheet or a halyard on a sailing boat. More specifically, the invention relates to a self-tailing arrangement on such a winch in combination with such a winch also allowing veering-out of sheet or halyard rope arranged thereon by means of means that normally otherwise are intended for sheeting-in, more precisely a crank possibly having an appurtenant transmission integrated in the winch or the corresponding motor drive and appurtenant transmission.

### BACKGROUND

Self tailing as a concept exists since before in connection with sailing boat winches, however as far as has been found by extensive investigations, not in combination with a possibility of, by means of normal means for sheeting-in, also veering out rope. In self-tailing units of winches of traditional type, the principal idea is that the winch, by this unit, by itself should handle the free unloaded end of the rope (“the tail”) and deliver this to the yachtsman in a certain direction, suitably toward the cockpit of the boat. When applying this technology to winches that allow also veering-out of rope, trouble arises by the fact that the drum radius on which the rope of the self-tailing unit runs, for achieving the best function of ropes in the span that the winch is constructed for, is somewhat greater than the corresponding drum radius of the winch drum itself.

Because of this, in connection with the possibility being given to veer out rope by self-tailing winches, a minor sliding of the rope between the self-tailing unit and the winch drum arises. This sliding causes the rope to get a tendency to lose the grip from the self-tailing unit with the risk that, for instance, the sheet, admittedly depending on how many turns this lies around the winch drum, may come to unintentionally be veered out in an uncontrolled way, something that cannot be accepted for, among other things, safety reasons. The fact that the self-tailing function has the design that it generally has, as far as has been found, depends on that the strongly spring-biased rope guide rings, which in such a unit surround the rope, together form a truncated cone as seen in cross-section, which may be said to stand on its truncated end with the top of the same directed toward the axis of the rope drum. Each such rope guide ring is furthermore provided with grooves that run obliquely outward from the inner part of the rope guide rings, the purpose of which is to press in the rope between rope guide rings in connection with sheeting-in. This design has probably been come into existence as a fairly simple solution to handle and convey the loose end that results in connection with sheeting-in, without any closer idea of further development. The tests that have been made with self-tailing winches of this type have verified that it is not possible to use a traditional construction of the self-tailing unit if it should be feasible to give the winch a possibility of also being able to veer out rope by the same means that are used for sheeting-in.

### THE INVENTION IN BRIEF

It is therefore an object of the present invention to provide a proceeding and an arrangement by which, in connection with a winch of self-tailing type and in the way indicated above, it becomes possible, in addition to undertaking sheeting-in by such a winch, to also veer out rope to the desired extent by using the same means that are used for the sheeting-in.

According to the invention, either of the rope guide rings is spring-mounted in such a way that the same is given a static and dynamic motion pattern that means that, in connection with the spacing between the rings somewhere along their periphery being widened, the corresponding spacing on the opposite side of the rings is decreased to an equivalent extent.

In this way, in all essentials the rope is prevented from, in the way described earlier in connection with veering-out of the same, as a consequence of skidding between the rope and the rope guide rings of the self-tailing unit, unintentionally coming loose from the self-tailing unit and causing rope to be veered out unintentionally and uncontrolled thereby risking life and limb.

According to a preferred further developed embodiment of the invention, adjacent to the means for directing the rope into and out of the same, the self-tailing unit is provided with means for, against the force from the resilient means of the movable rope guide ring, compulsory affecting the last-mentioned one so that the spacing between the rope guide rings is widened with the purpose of supporting the introduction of the rope between the rope guide rings.

In this way, it is achieved that a very distinct channel surrounds the rope, which, what is more, clamps around the rope at one shown side of the winch in such a way that the rope is prevented from sliding out from the gap between the rope guide rings on this side.

According to an additional preferred, further developed embodiment of the invention, the means affecting the movable rope guide ring compulsory are arranged on the means for directing the rope into and out of the self-tailing unit.

By this procedure, in addition to the advantages in pure handling are achieved in a simple way at the same time as production-technical such advantages are clearly achieved without major effort.

According to a particular further developed embodiment of the invention, at least one of the rope guide rings' outer edge has a bulge that is facing the outer edge of the other rope guide ring.

By means of this edge, the rope can by an even better effect be retained in the groove or chute that has straight edges and is formed of the rope guide rings in connection with the same surrounding the rope in the range of the gap between the rings that is narrowest.

### BRIEF DESCRIPTION OF THE DRAWINGS

In the following, the invention will be described in more detail with the aid of a preferred embodiment example shown in the appended drawings, wherein,

FIG. 1a shows a side view of a sailing boat winch having self-tailing function as well as a rope arranged around the drum of the winch and the self-tailing unit thereof,

FIG. 1b shows a side view of a sailing boat winch corresponding to the one in FIG. 1a, in this embodiment however provided with a different design of rope guiding arrangement,

FIG. 2a shows a cross-section along the line IIa-Ia in FIG. 1 a of a winch, in all parts corresponding to the embodiment in FIG. 1a,

FIG. 2b shows a cross-section corresponding to FIG. 2a with the difference that a rope is shown between the rope guide rings,

FIG. 3 shows the principal function of a self-tailing unit according to the invention,

FIG. 4 shows schematically the function of the self-tailing unit in a first principal embodiment, and

FIG. 5 shows schematically the function of the self-tailing unit in a second principal embodiment.

### DETAILED DESCRIPTION

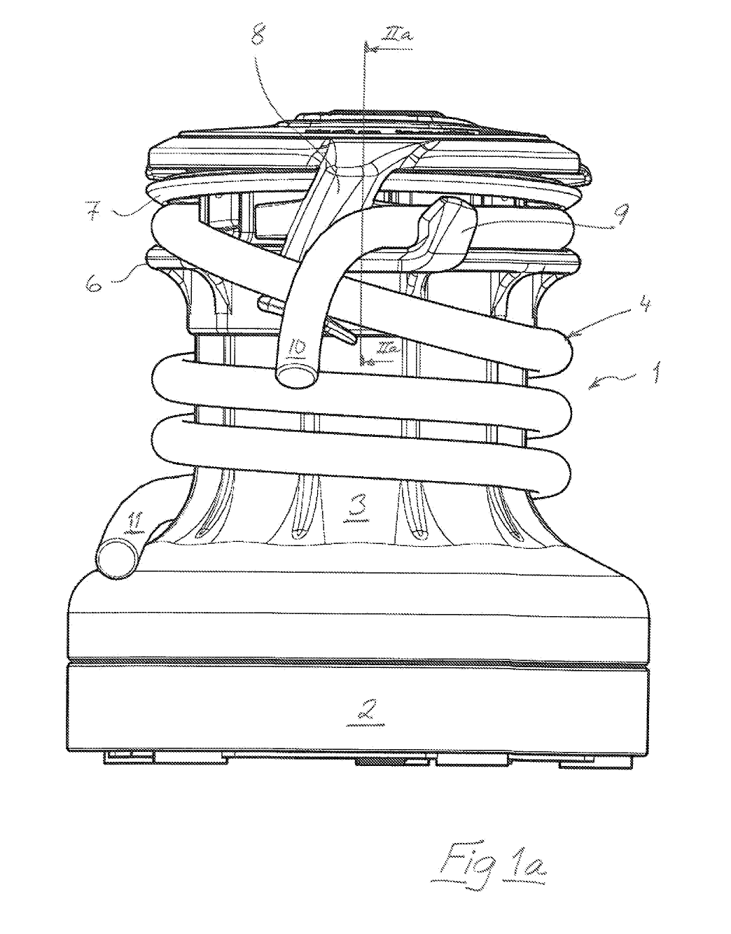

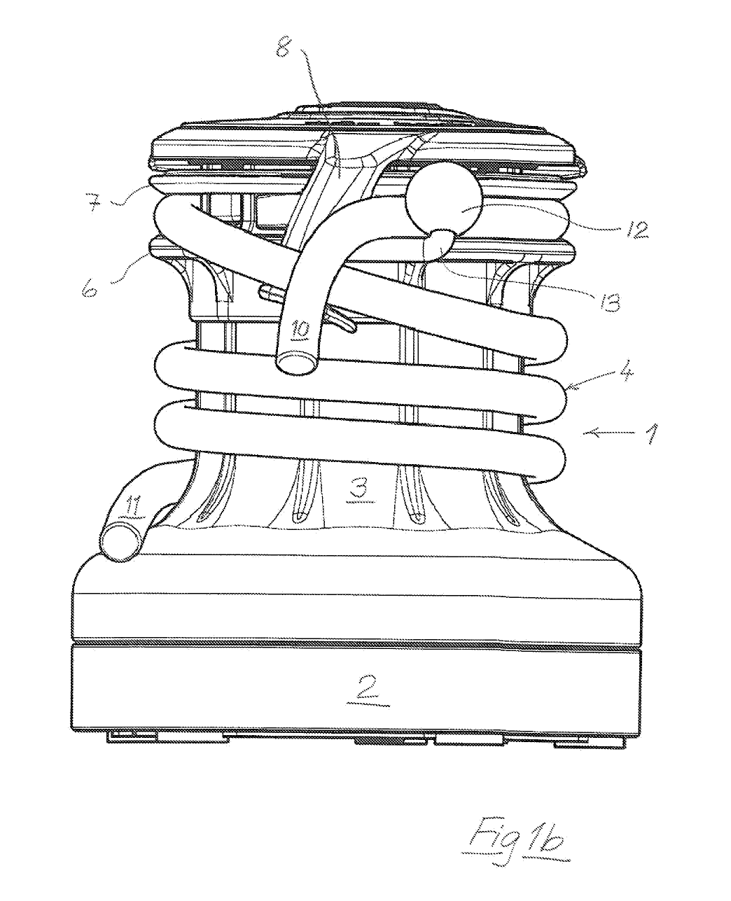

In FIG. 1a attached, there is seen a winch 1 that has its application in the area of sailing. In the embodiment shown, the winch embraces a frame 2, a drum 3, around which a rope 4 is wound in the case shown here. The drum 3 is rotatably mounted in relation to the frame 2 and has on its inside more or less sophisticated arrangements of the type backstops, transmissions, brakes, motors, etc., which in this context are incidental. At its upper part, the drum 3 has a self-tailing arrangement 6, 7, 8, 9, by means of which a rope 4 wound around the drum in connection with sheeting-in is intended to be delivered to the yachtsman in a predetermined and adjustable direction. The self-tailing arrangement 6, 7, 8, 9 embraces a lower fixed rope lock ring 6 and an upper horizontally limited controlled movable rope lock ring 7. Upon use for sheeting-in, an inner rope guide 8 fixed at the frame 2 contributes to direct the rope in the selected direction at the same time as it forces the rope out of the gap between the rope lock rings 6, 7. On the other hand, in connection with loosening of a sheet, it is on the contrary about to direct the rope in between the rope lock rings 6, 7. For this purpose, a rope guide 9 that projects from an intermediate portion of the rope guide 8 is arranged to direct the rope in between the rope lock rings 6, 7 in connection with the winch drum rotating, into a portion of the gap between the rope lock rings 6, 7 that for the purpose are brought apart in a way described below. It should be observed that the end of the rope that here has been designated by 10 is the end that is free and unloaded, while the other end 11 is the one by which, for instance, the sheeting operation is carried out and that consequently is loaded.

In comparison with FIG. 1a, FIG. 1b shows an alternative embodiment of self-tailing arrangement 6, 7, 8, 12 the only actual difference of which is constituted by the rope guide arm 9 in the embodiment according to FIG. 1a having been replaced by a rotatable ball 12 that is arranged on an arm 13 in a spring-biased turnable way, the axis of rotation of which in the rope guide 8 is perpendicular to the axis of the drum 3.

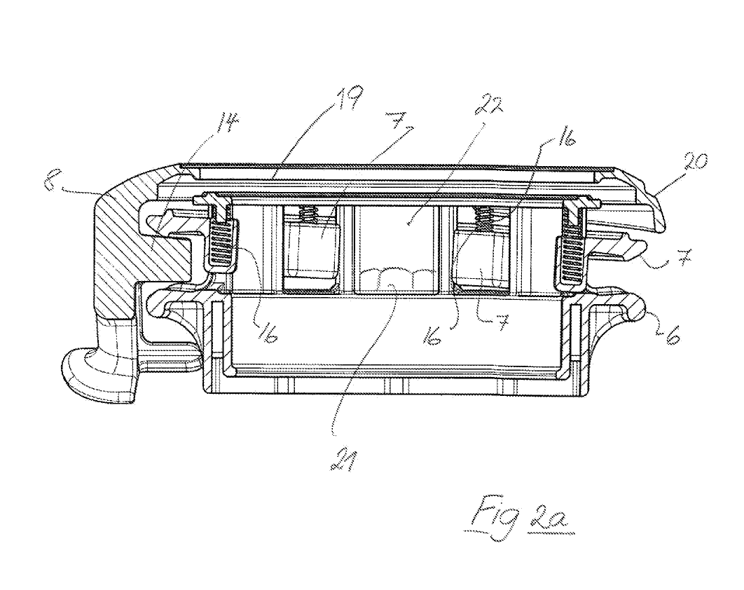

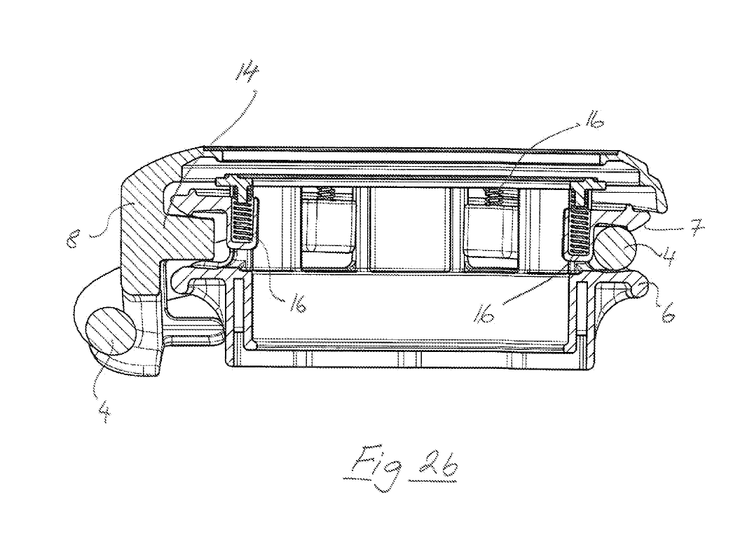

FIG. 2a, which is a cross-section along the line IIa-IIa in FIG. 1a of a self-tailing arrangement without drum 3, shows what is more the arrangement without rope. This in order to clearly show how, in this embodiment, the upper rope lock ring 7, by means of a rope extractor 14 on the side (back side) of the rope guide 8 that normally is invisible in FIGS. 1a and 1b, is lifted up against the action of springs 16 that are acting on the upper rope lock ring 7 and arranged in seats 15. In this embodiment, the number of springs 16 is six, which of course may be varied as desired. This results in that the spacing between the rope lock rings 6 and 7 varies around the turn, which results in the extraordinarily desirable effect that a rope 4 becomes easy to guide into and veer out of, respectively, the gap between the rope lock rings 6, 7 while it being clamped between said rings in a position at an arc length of π/2 radians from the position of the rope extractor 14. It is further seen in this figure how a cover ring 19, with which the rope guide 8 is integral, on the side thereof opposite the rope guide 8 has a guiding 20 for insertion of the rope between the rope lock rings 6 and 7. In this connection, it should be pointed out that the self-tailing arrangement (6, 7), which should be fixed in relation to the drum 3, may be fixed to the winch frame 2 in different ways, such as, for instance, by means of a screw joint 21 that is arranged in the recess 22 in the self-tailing arrangement.

This is illustrated, if possible, even clearer in FIG. 2b, which is a view corresponding to FIG. 2a, with the essential difference that the self-tailing arrangement here is shown with a rope 4 arranged between the rope lock rings 6, 7. Depending on the thickness of the rope 4 (obviously a rope in the rope thickness range for which the winch is dimensioned), this is held fixed in a clearly shown way between the rope lock rings 6, 7 during the approximately half turn that the rope runs through the self-tailing arrangement. It should be considered obvious that the self-tailing arrangement of the winch may be provided with rope extractors having different lift height depending on in which application and for which load the winch is constructed. Likewise, it is very simple to alter the direction in which the self-tailing arrangement in connection with sheeting-in delivers rope to the yachtsman, by upper part of the self-tailing arrangement, with the rope guide 8 integrated, being made with co-operating toothings (not shown) that are such that the parts in connection with mounting can be easily assembled in such a way that the self-tailing arrangement can deliver the rope in the desired direction.

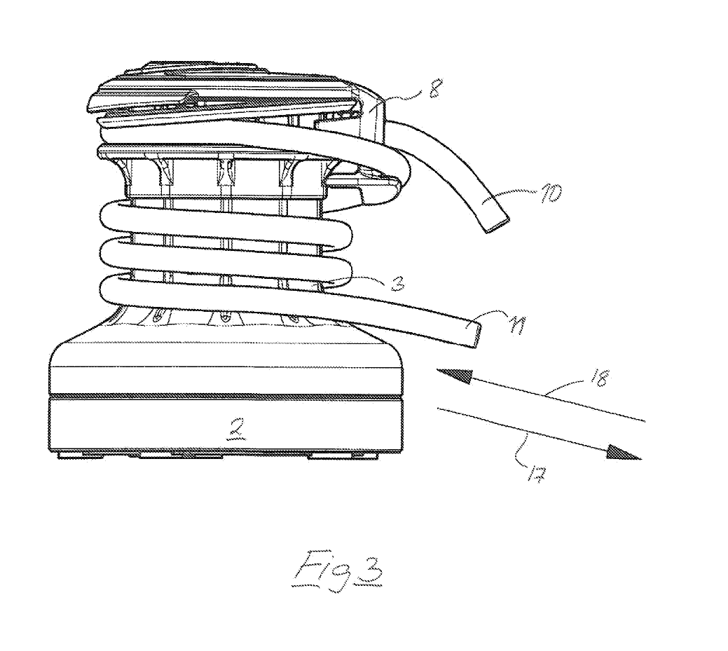

In FIG. 3, the rope winch 1 provided with a self-tailing arrangement 6, 7, 8, 9 according to the invention is seen as a view rotated counter-clockwise an arc length of π/4 radians in comparison with FIG. 1a. From this view, there are clearly seen the mutual inclination between the rope lock rings 6, 7, how the rope is inserted between said rings by means of the rope guide 8, how the curved unloaded end 10 of the rope 4 is left to a conceived yachtsman, as well as by arrows 17, 18 how the loaded end 11 of the rope 4 leaves or contacts the drum 3 on one hand in connection with loosening of a sheet or, on the other hand, in connection with sheeting-in.

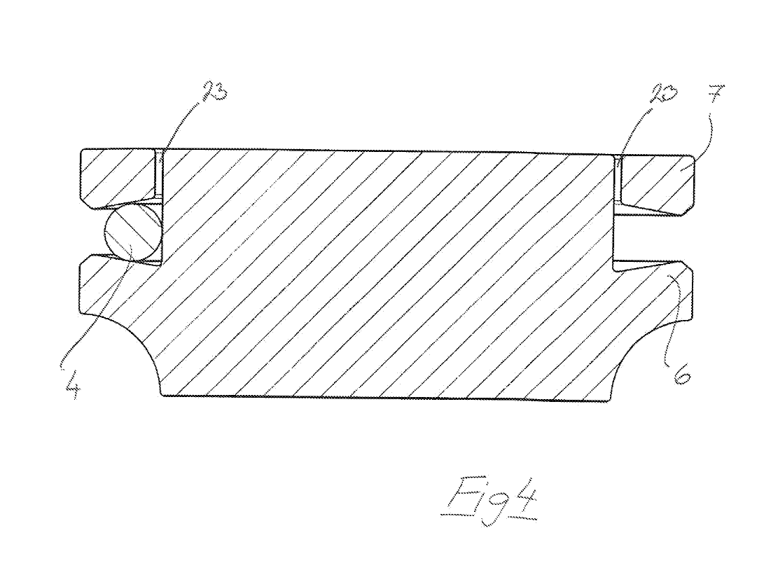

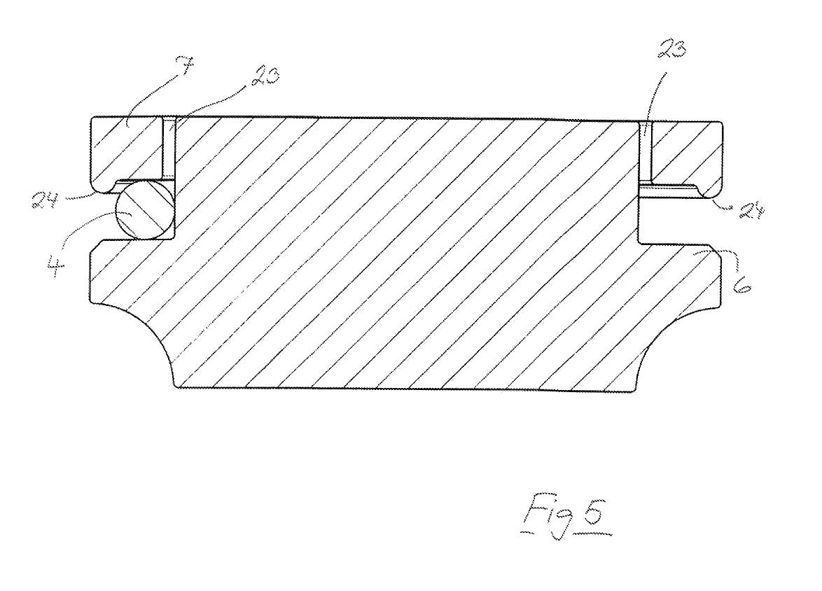

In FIGS. 4 and 5, simple schematic cross-sections through two different variants of fixed and movable rope lock rings 6 and 7, respectively, are seen. In the case seen in FIG. 4, both the fixed and the movable rope lock ring are formed so that the channel formed between the same widens toward the centre of the winch drum so that a rope 4 applied between the same will be forced to remain between the rings until the spacing between them is widened under the impact of the rope extractor 14 or another forcing means, for instance, a rope acted on by a ball 12 and the rope extractor 14. Such a widening is possible thanks to the play 23 between the upper part of the lower rope lock ring 6 and its upper counterpart 7 shown in the figure. In the alternative embodiment according to FIG. 5, the lower rope lock ring 6 is entirely straight and perpendicular to the symmetry axis of the drum 3, while the upper rope lock ring 7 is distinguished by a marked bulge formation 24 at its outer edge for allowing to retain a rope 4 applied between the lock rings 6, 7 without this randomly falling out and thereby constituting a safety risk. The invention should not be regarded as limited by the embodiment example described above but instead by accompanying claims.

1.-5. (canceled)

6. A self-tailing unit for a boat winch having a frame and a drum, the winch configured such that a rope arranged on the drum can be veered out and sheeted in, and the self-tailing unit being arranged at an upper end of the winch, the self-tailing unit comprising:
upper and lower rope lock rings, and
means in relation to the frame for directing the rope into and out of the self-tailing unit in a controlled way,
wherein either of the rope lock rings is skew spring-mounted such that during one revolution the spring-mounted rope lock ring is given, directly or indirectly via a rope extractor, a dynamic motion pattern, whereby a spacing between the rope lock rings is widened so that the rope lock rings are brought apart in an area where the rope for veering out is guided between the rope lock rings, and the rope is let in past at least one bulge arranged on one of and between the rope lock rings.

7. The self-tailing unit of claim 6, further comprising means, adjacent to the rope extractor, for moving the spring-mounted rope lock ring so that the spacing between the rope lock rings locally adjacent to the moving means is widened to enable introduction of the rope between the rope lock rings.

8. An arrangement for a boat winch having a frame, a drum, and a self-tailing unit arranged at an upper end of the drum, the winch configured such that a rope arranged on the drum can be veered out and sheeted in by driving the drum, and the self-tailing unit having upper and lower rope lock rings and an arm for directing the rope into and out of the self-tailing unit in a controlled way, the arrangement comprising:
means for suspending and spring-mounting at least one of the rope lock rings, the suspending and spring-mounting means being configured such that the rope lock rings, under impact of a rope extractor, obtain a mutually dynamic motion pattern such that the rope lock rings are forced apart near the rope extractor, thereby facilitating introduction of rope from the drum and introduction and extraction of a free unloaded end of the rope past a bulge arranged at an outer periphery of at least one of the rope lock rings at the same time as the bulge retains the rope in a fixed grip at an area of the rope lock rings diametrically opposite the rope extractor.

9. The arrangement of claim 8, wherein the rope lock rings, viewed in cross-section in a direction corresponding to a direction of a rope running between them, together form a cavity that is substantially ring-shaped in a longitudinal direction thereof and has straight edges.

10. The arrangement of claim 8, wherein the rope extractor is arranged such that a side of a rope guide for sheeting-in faces a rotation axis of the winch.

11. The arrangement of claim 10, wherein the rope lock rings, viewed in cross-section in a direction corresponding to a direction of a rope running between them, together form a cavity that is substantially ring-shaped in a longitudinal direction thereof and has straight edges.
